(19) United States
(12) Patent Application Publication
(10) Pub. No.: US 2009/0320762 A1
(43) Pub. Date: Dec. 31, 2009

(54) Sow feeder with a roll feed transport mechanism

(76) Inventor: Jung Wei Chang, Taichung (TW)

Correspondence Address: SAM CHEN, 7F-1, 293, ROOSEVELT ROAD, SEC 3, TAIPEI, TW

(21) Appl. No.: 12/164,102

(22) Filed: Jun. 30, 2008

(51) Int. Cl. A01K 5/01

(52) U.S. Cl. 119/53

(57) ABSTRACT

A sow feeder mounted at the gate of a sow stall is disclosed. The sow feeder includes a roll feed transport mechanism located at a feed discharge opening of a feed hopper so that a sow may actuate the roll feed transport mechanism by upward pushing by the snout prior to eating feed material discharged into a feed collecting trough.

### BACKGROUND OF THE INVENTION

1. Field of Invention

The invention relates to animal feeding devices and more particularly to a feeder having a roll feed transport mechanism located at a feed discharge opening of a hopper so that a sow may actuate the mechanism by the snout prior to eating discharged feed material.

2. Description of Related Art

Conventionally, a sow is confined in a stall (e.g., sow stall or gestation crate) in piglets breeding period. It is typical for a farm employee to regularly pour feed material into a feed collecting trough of a feeder located at the gate of the stall so that a sow may eat the feed material. However, sows may have different amounts of feed consumption. Hence, it is possible that some sows may have consumed feed material prior to the feed supply time. That is, some sows may be hungry prior to feed supplying and it is not desirable. Further, problems such as feed clogging, laborious cleaning or the like may occur.

There have been numerous suggestions in prior patents for animal feeder. For example, U.S. Pat. No. 4,729,076 discloses an animal feeder having a drum feed transport device. Thus, continuing improvements in the exploitation of animal feeder are constantly being sought.

### SUMMARY OF THE INVENTION

It is therefore one object of the invention to provide a sow feeder having a roll feed transport mechanism located at a feed discharge opening of a feed hopper so that a sow may actuate the mechanism by the snout prior to eating feed material discharged into a feed collecting trough.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of sow feeder according to the invention;

FIG. 2 is a longitudinal sectional view of the feeder of FIG. 1;

FIG. 3 is a front view of the feeder mounted at the gate of a sow stall;

FIG. 4 is a longitudinal sectional view of the feeder of FIG. 3 with feed material filled in a feed hopper; and

FIG. 5 is a view similar to FIG. 4 where feed material is being released into the feed collecting trough by pushing the feed discharge roll upward and water is flowing onto the feed material in the feed collecting trough by opening the valve by pivotably pushing.

### DETAILED DESCRIPTION OF THE INVENTION

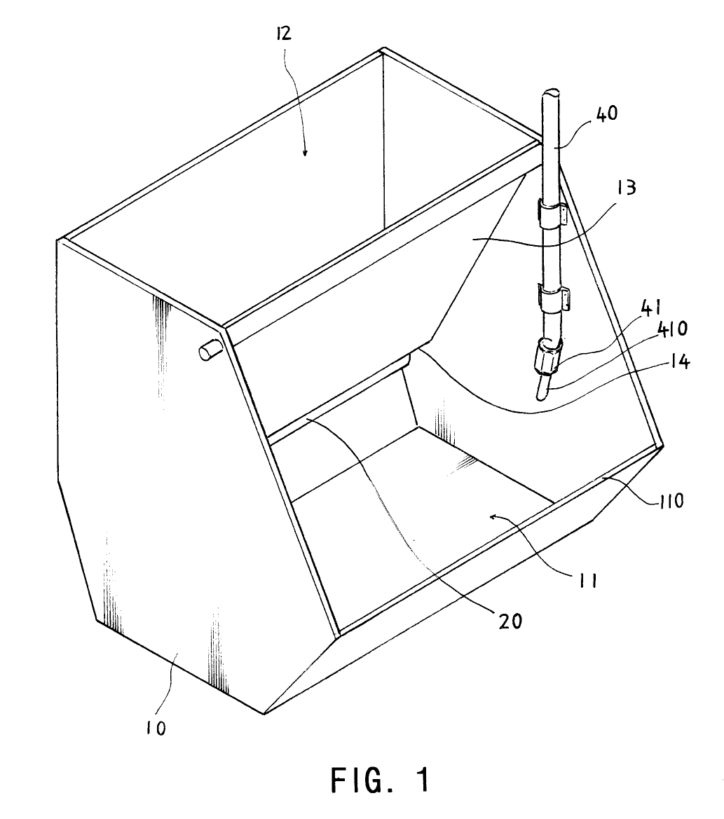

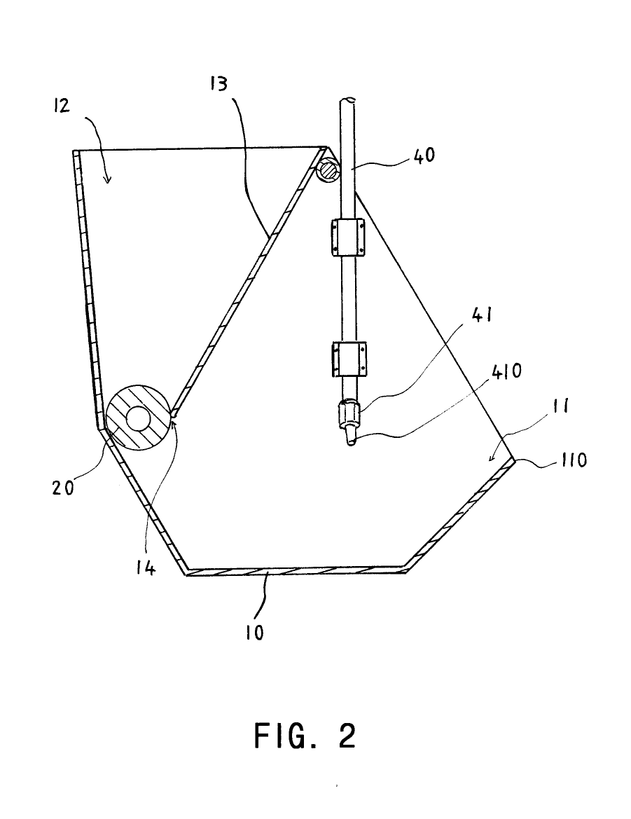

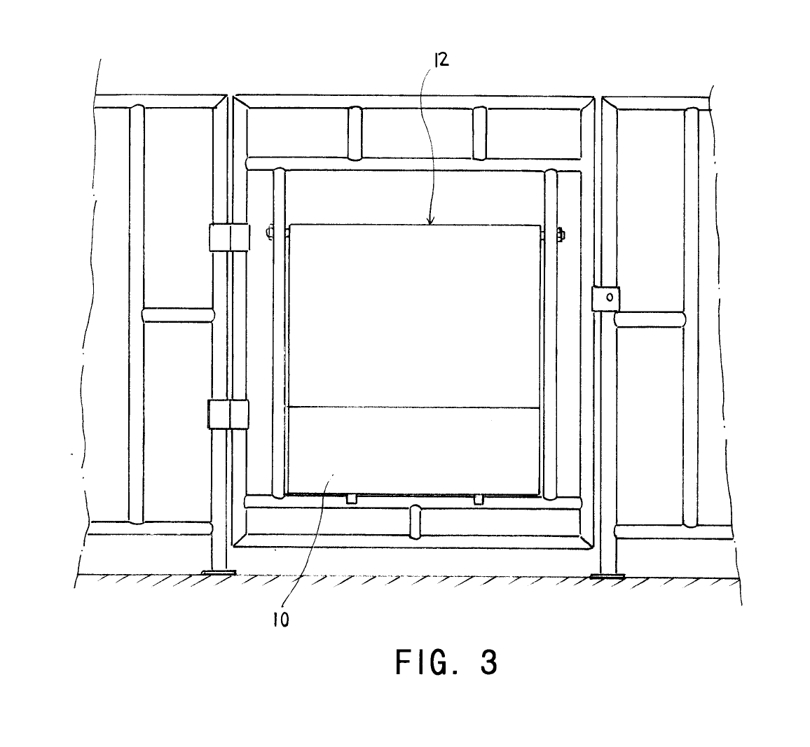

Referring to FIGS. 1 to 5, a sow feeder 10 in accordance with a preferred embodiment of the invention is shown. The sow feeder 10 is mounted at the gate of a sow stall (see FIG. 3).

The sow feeder 10 comprises an upper feed hopper 12 having a front inclined wall 13 for facilitating free downward flow of feed material contained therein as detailed later, two side walls (not numbered), a rear vertical wall (not numbered), and a transverse bottom opening 14 defined by the inclined wall 13, the vertical wall, and the side walls; a feed discharge roll 20 rested upon the opening 14; a lower feed collecting trough 11 having a front inclined wall 110, two side walls (not numbered) depending downward from the side walls of the feed hopper 12, a rear inclined wall (not numbered) obliquely depending downward from the vertical wall of the feed hopper 12; and a water supply duct 40 mounted on the inner surface of the other side wall of the sow feeder 10, the water supply duct 40 having an end valve 41 with a pivotal actuation handle 410.

Preferably, height of the inclined wall 110 is slightly lower than the elevation of the feed discharge roll 20.

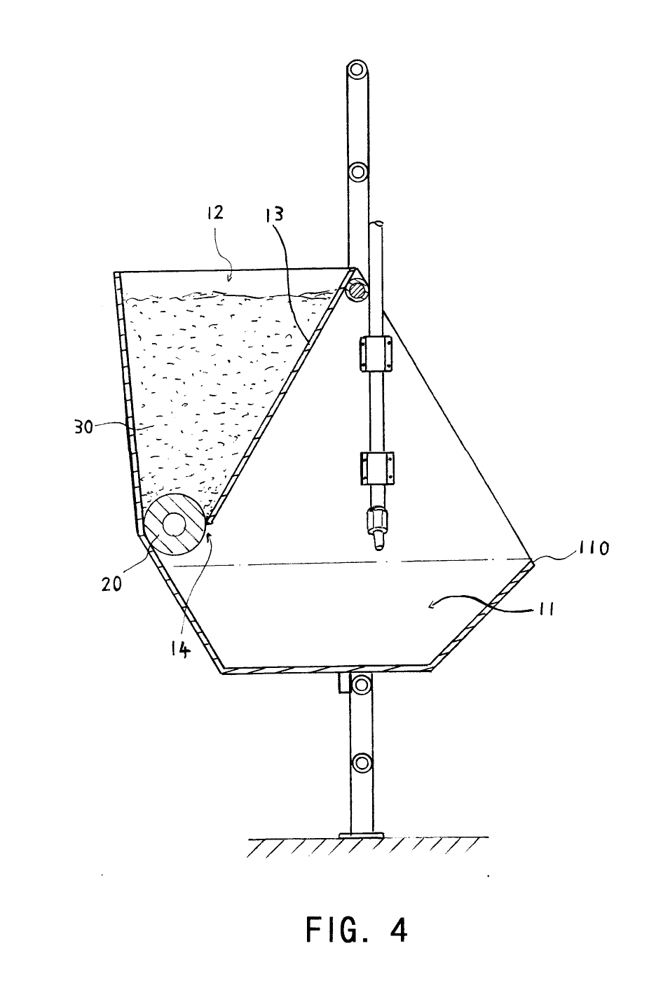

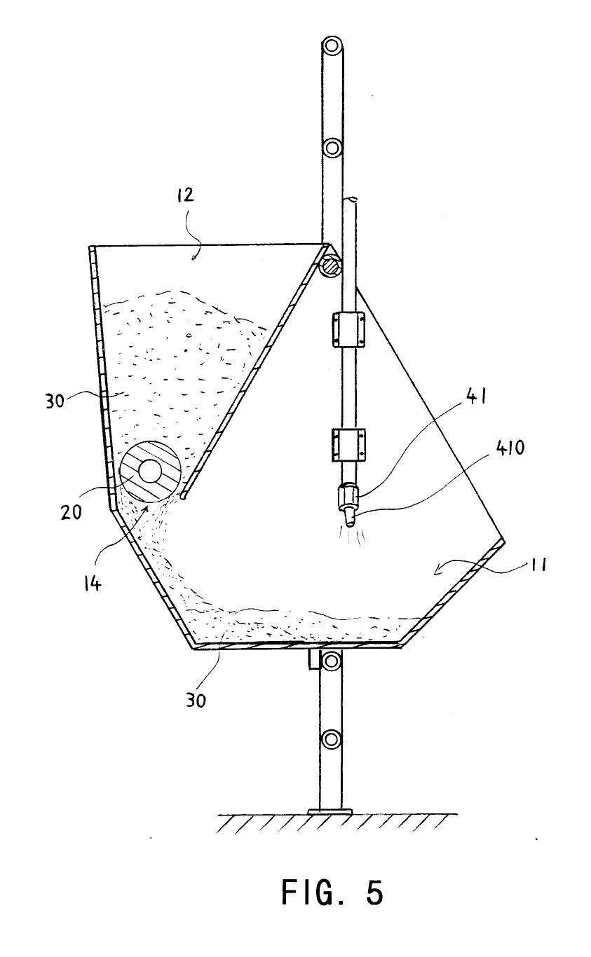

A farm employee may regularly pour feed material 30 into the feed hopper 12 with the opening 14 being blocked by the feed discharge roll 20 (see FIG. 4). As shown in FIG. 5, a hungry sow confined in the stall may continuously actuate the feed discharge roll 20 (i.e., push it upward) by striking by the snout in order to unblock the opening 14. Hence, feed material 30 in the feed hopper 12 may be slowly and evenly discharged from the feed hopper 12 into the bottom of the feed collecting trough 11 through the opening 14. Moreover, the sow may open the valve 41 by pivotably pushing the actuation handle 410. As a result, water flows from the water supply duct 40 into the feed material 30 in the feed collecting trough 11 to mix therewith so as to form a wet feed material for ease of eating.

While the invention herein disclosed has been described by means of specific embodiments, numerous modifications and variations could be made thereto by those skilled in the art without departing from the scope and spirit of the invention set forth in the claims.

What is claimed is:

1. A sow feeder comprising:
a feed hopper having a transverse bottom opening;
a feed discharge roll rested upon the opening;
a feed collecting trough disposed below the opening; and
at least one water supply duct having a valve and mounted on the feed collecting trough;
wherein the opening is adapted to open by actuating the feed discharge roll to discharge feed material from the feed hopper into the feed collecting trough, and each of the at least one valve is adapted to open by pivotably pushing.

2. The sow feeder of claim 1, wherein the number of the at least one water supply duct is one.

3. The sow feeder of claim 2, wherein the water supply duct is mounted on one side of the feed collecting trough.
